(19) United States
(12) Patent Application Publication
(10) Pub. No.: US 2012/0201441 A1
(43) Pub. Date: Aug. 9, 2012

(54) METHOD AND MAGNETIC RESONANCE SYSTEM TO REMOVE UNWANTED, PERFUSION-DEPENDENT SIGNALS FROM MR IMAGES

(76) Inventor: Andre De OLIVEIRA, Erlangen (DE)

(21) Appl. No.: 13/365,952

(22) Filed: Feb. 3, 2012

(30) Foreign Application Priority Data
Feb. 3, 2011 (DE) 10 2011 003 606.7

(51) Int. Cl. G06K 9/00

(52) U.S. Cl. 382/131

(57) ABSTRACT

In a method and magnetic resonance system for the removal of unwanted, perfusion-dependent signals from MR images, a series of MR images, that are acquired in a chronological progression and registered with one another, are loaded into a processor. In the processor, a spectrum of the time curve of the intensity of each image unit of the registered MR images in a selected region is created, a spectral range is determined with which the perfusion is to be associated, the spectra is filtered based on the determined spectral range, perfusion-corrected MR images are reconstructed by converting the filtered spectra back within the time domain. The perfusion-corrected MR images are displayed at a display unit and/or the perfusion-corrected MR images are stored at a memory unit.

### BACKGROUND OF THE INVENTION

1. Field of the Invention

The invention concerns a method to remove unwanted, perfusion-dependent signals from MR images, and a magnetic resonance system and a non-transitory, computer-readable storage medium to implement such a method.

2. Description of the Prior Art

Magnetic resonance (MR) is a known modality with which images of the inside of an examination subject can be generated. Described simply, the examination subject is positioned in a strong, static, homogeneous basic magnetic field B0 (field strengths of 0.2 Tesla to 7 Tesla or more) in a magnetic resonance data acquisition unit (scanner) so that nuclear spins in the subject orient along the basic magnetic field. For spatial coding of the measurement data, rapidly switched gradient magnetic fields are superimposed on the basic magnetic field. To trigger nuclear magnetic resonances, radio-frequency excitation pulses (RF pulses) are radiated into the examination subject by at least one transmission coil, the triggered magnetic resonance signals are measured by one or more reception coils, and anatomical MR images (for example) of the examination subject are reconstructed on the basis of the measured signals.

MR technology can be used to image the lungs, but this presents certain problems because a lung primarily contains air and has a basic tissue structured similar to a sponge, so this tissue has only a low proton density. Nevertheless, MR technology—in particular even without the use of contrast agent or ionizing radiation—enables information about important functions of the lung (ventilation and perfusion, for example) to be obtained.

Ventilation is the technical term for the aeration of the lungs during breathing. This should optimally take place uniformly in order, in the ideal case, to distribute the inhaled air in all alveoli and to exhale metabolic products such as carbon dioxide. The supply of the lungs (or of organs or organ parts in general) with blood is designated as perfusion. The supply takes place via arteries, the outflow via veins. This serves to supply tissues with elements (such as oxygen and nutrients) transported in the blood, and to transport away metabolic products and carbon dioxide.

For example, the article by Bauman et al., “Non-Contrast-Enhanced Perfusion and Ventilation Assessment of the Human Lung by Means of Fourier Decomposition in ProtonRI”, Magnetic Resonance in Medicine 62:656-644 (2009) describes a method to acquire ventilation-weighted and perfusion-weighted image data sets via Fourier decomposition of a series of MR images of the lung that were acquired with free breathing and without triggering or gating. This technique enables a qualitative assessment of the ventilation and the perfusion.

In the article by Zapke et al., “Magnetic resonance lung function—breakthrough for lung imaging and functional assessment? A phantom study and clinical trial”, Respiratory Research 2006, 7:106, a method for MR imaging is described in which thick slices (20 to 200 mm thick) in the examination region of the lung are measured under application of a low basic magnetic field (0.2 T). By processing the data of a series of such measurements, the ventilation occurring in the measured segment of the lung can be quantified. In this method, however, influences due to perfusion are either ignored or the series of measurements must be triggered relative to the heart beat in order to acquire only respective MR images of the same phase of the cardiac cycle. Correspondingly, in a further article by the authors on the same topic—Rupprecht et al., “Pathologische regionale Ventilation bei symptomfreien Patienten mit Asthma bronchiale” [“Pathologic regional ventilation in symptom-free patients with bronchial asthma”], Kind & Radiologie Volume 16, 2/2008, P. 16-21,—it is indicated that cardiac triggering is used in the acquisition of the MR images with a HASTE sequence at 1.5 T. In particular given acquisitions with higher basic magnetic field (as of approximately 1.5 T), without such a triggering artifacts caused by the perfusion interfere with the acquisitions such that they can no longer be used for the described method to quantify the ventilation.

### SUMMARY OF THE INVENTION

An object of the present invention is to provide a method, a magnetic resonance system, and an electronically readable data medium with which a contribution in MR images that is caused by perfusion can be removed quickly and efficiently.

A method according to the invention for the removal of unwanted, perfusion-dependent signals from MR images includes loading a series of MR images into a processor that are acquired in a chronological progression and registered with one another, and in the processor, creating a spectrum of the time curve of the intensity of each image unit of the registered MR images in a selected region, determining a spectral range with which the perfusion is to be associated, filtering the spectra based on the determined spectral range, reconstructing perfusion-corrected MR images by converting the filtered spectra back within the time domain, and causing the perfusion-corrected MR images to be displayed at a display unit and/or store the perfusion-corrected MR images at a memory unit.

The method according to the invention quickly and efficiently removes perfusion-dependent signals from MR images, and thus allows an evaluation of the MR images that are therefore perfusion-corrected, without having to be concerned about or account for influences on the results of the evaluation due to the perfusion. In the acquisition of the MR images no special efforts need to be made to avoid influences due to perfusion or to keep such influences the same in every image (for instance by means of a triggering or a gating of the acquisitions relative to the cardiac cycle). Rather, the exposures can be acquired with an efficient, quick temporal spacing, as well as with free breathing, for example.

This is primarily advantageous if the series of MR images acquired in a chronological progression shows at least a portion of a lung.

Furthermore, in such an exemplary embodiment at least one ventilation value can be determined by comparing the intensity value of an image region of interest from at least two of the perfusion-corrected MR images.

Even a quantitative determination of the at least one ventilation value (as described with regard to FIG. 2 below) is possible. With a method that can be applied with administration of contrast agent and that uses no ionizing radiation, the possibility is available to make quantified statements about the ventilation in a region of the lung shown in the acquired MR images. Moreover, the acquisition of the MR images can take place efficiently and quickly for the purposes of the method according to the invention.

A magnetic resonance system according to the invention has a magnet unit, a transmission/reception device, a gradient system and a control device. The control device controls the transmission/reception device and the gradient system such that a series of MR images of an examination subject are acquired in a chronological progression. Furthermore, the control device processes the acquired series of MR images such that these are registered with one another, and it processes them further corresponding to the method described above.

The above object also is achieved in accordance with the present invention by a non-transitory, computer-readable data storage medium encoded with programming instructions. When the data storage medium is loaded into a computerized control and evaluation system of a magnetic resonance apparatus, the programming instructions cause the above-described method to be implemented.

The advantages and embodiments described with regard to the method analogously apply to the magnetic resonance system, as well as to the electronically readable data medium.

### BRIEF DESCRIPTION OF THE DRAWINGS

FIG. 1 schematically illustrates a magnetic resonance apparatus to implement the method in accordance with the invention.

FIG. 2 is a schematic representation of a workflow of the method according to the invention.

FIG. 3 schematically shows a series of MR images acquired in a chronological progression, with an associated curve of the intensity of the acquired signals in the same respective pixel in each MR image of the series.

FIG. 4 schematically shows a series of MR images acquired in a chronological progression and registered with one another, with an associated curve of the intensity of the acquired signals in the same respective pixel in each MR image of the registered series.

FIG. 5 schematically shows a temporal spectrum calculated from an intensity spectrum according to FIG. 4 (for example) in comparison to a correspondingly filtered spectrum.

FIG. 6 schematically shows a series of perfusion-corrected MR images shown in chronological progression, with an associated curve of the intensity of the signals in the same respective pixel in each MR image of the perfusion-corrected series.

### DESCRIPTION OF THE PREFERRED EMBODIMENTS

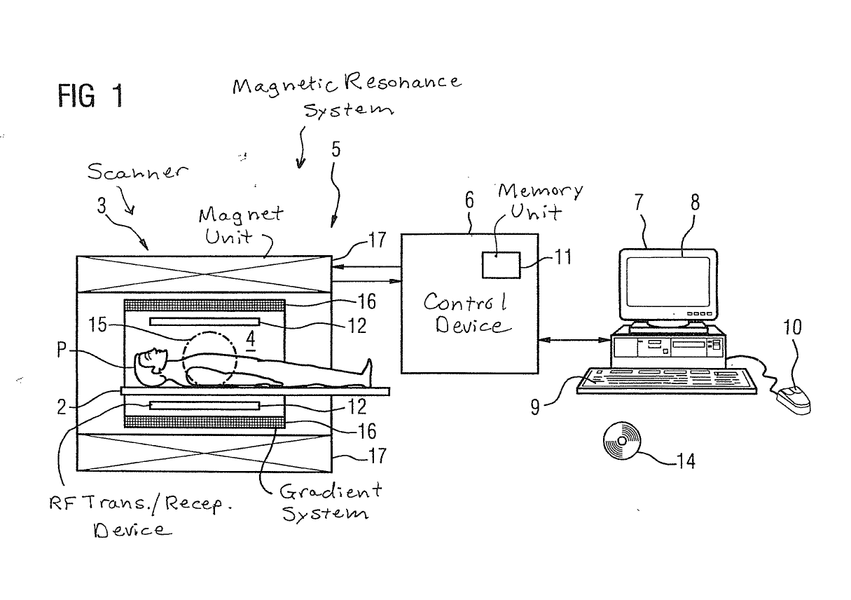

A magnetic resonance system 5 according to the invention is schematically shown in FIG. 1. The magnetic resonance system 5 basically includes a scanner 3 with a magnet unit 17, a gradient system 16 with which the magnetic field (including gradient field) necessary for the MR examination is generated in a measurement space 4, a transmission/reception device 12 to transmit RF excitation pulses and acquire echo signals; a table 2, a control device 6 with which the scanner 3 is controlled and raw data from the scanner 3 are received, and a terminal 7 connected to the control device 6. The transmission/reception device 12 can include separate transmission and reception units and/or switchable transmission and reception units.

The control device 6 can control the transmission/reception device 12 and the gradient system 16 such that a time series of MR images is acquired.

During the generation of an MR image, echo signals are received by the transmission/reception device 12 by the scanner 3, with the gradient system 16 and the transmission/reception device 12 activated by the control device 6 such that MR data located in a measurement volume 15 (which is located inside the body of an examination subject—a patient P, for example—lying on the table 2) are acquired. In particular, the examination subject located in the measurement volume is affected by perfusion, and possibly additionally by ventilation.

The control device 6 receives the acquired echo signals as raw data and stores and processes these with the use of a memory unit 11. The control device 6 processes the read-out raw data via reconstruction such that they can be graphically presented at a display unit 8 (for example on a monitor 8) of the terminal 7. Furthermore, the control device also can already additionally process raw data converted into image data, or already processed, stored image data or raw data. MR images can also be processed according to the method according to the invention. The processing of the acquired raw data and/or image data can alternatively or additionally be implemented at a computer of the terminal 7, or another computer spatially separate from the magnetic resonance system.

In addition to the graphical presentation of the image data reconstructed from the image data, with the terminal 7 (which has an input device, for example a keyboard 9 and/or a computer mouse 10 in addition to the monitor 8) a three-dimensional volume segment to be measured can be predetermined by a user as an imaging area, for example, and additional parameters for implementation of the method according to the invention can be determined. The software for the control device 6 can also be loaded into the control device 6 via the terminal 7. This software of the control device 6 can embody a method according to the invention. It is also possible for a method according to the invention to be included in software that runs on the terminal 7. Independent of the software in which the method according to the invention is contained, the software can be stored on an electronically readable data medium (for example a DVD 14) so that this software can then be read from the DVD 14 by the terminal 7 and can be copied either into the control device 6 or into a computer of the terminal 7 itself.

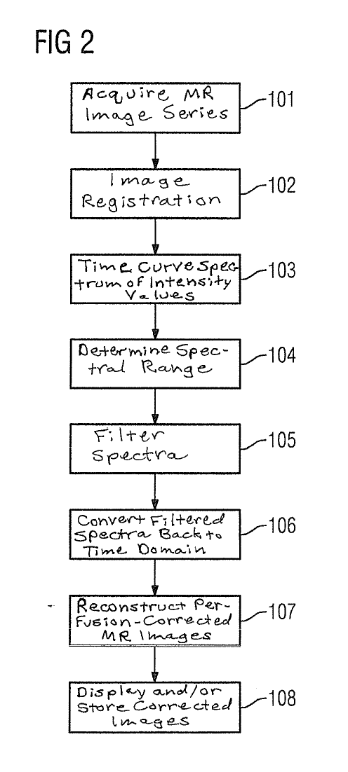

FIG. 2 schematically shows an exemplary workflow of a method according to the invention.

A series of MR images are acquired in a chronological progression (Block 101) with a magnetic resonance system. The series of MR images can be acquired, for example with an acquisition method mentioned in one of the articles cited above from Bauman et al. or Rupprecht et al. or Zapke et al. If a HASTE sequence described by Rupprecht et al. is used, a cardiac triggering can be omitted for the purposes of the present method. The series of MR images is acquired with the acquisition sequence described in the chapter “TrueFISP Sequence for Lung Imaging” of the article by Bauman et al. (P. 659, left column), since this takes particularly little acquisition time and therefore implements the acquisition of the MR images particularly quickly overall. For example, the acquisition duration can be reduced to approximately 1.5 minutes in this way.

In each case, for the present method the series of MR images can be acquired with free breathing and without triggering or gating, which also increases the comfort of the patient in addition to the rapidity.

The acquired MR images of the series are registered with one another (Block 102), for example in a control unit of the magnetic resonance system or also in another computer to which the series was supplied. The registration preferably takes place with an elastic registration method that requires no interaction with a user (for example a specification of markers or the like). Suitable registration methods are respectively referenced in the aforementioned articles by Bauman et al. and Zapke et al.

The MR images of the series that are registered with one another are additionally processed according to the invention. For this purpose they are loaded into the control unit of the magnetic resonance system or another computer (insofar as they are not already present), for example, and a spectrum of the time curve of the intensity of each image unit of the registered MR images in a selected region is created (Block 103). An image unit corresponds to a voxel or pixel of the MR images, for example. An example of a time curve of the intensity of a pixel in a series of MR images registered with one another is shown further below with reference to FIG. 4.

For example, the selected region can be the entire MR image or only the same partial region in each MR image in which the examination subject of interest is shown, for example the lung of a patient or a lung lobe or a partial region of the lung whose functionality should be examined. In a simple exemplary embodiment, a temporal spectrum is therefore created for each pixel in a selected region, for example by means of Fourier transformation of the intensity values of the pixel in the time curve.

In a further step a spectral range that is to be associated with the perfusion is determined (Block 104).

In a simple exemplary embodiment, the spectral range that is to be associated with the perfusion is limited to the range between 0.8 Hz and approximately 2 Hz, since this is generally the range in which the heart rate lies.

Alternatively or additionally, the spectral range that is to be associated with the perfusion can be limited based on the known cardiac frequency of the patient. For example, for this purpose the heart rate of the patient is determined by means of a suitable heart rate device. Such heart rate measurement devices or pulse measurement devices are known in the prior art. The spectral range to be associated with the perfusion can then be limited to the range of the measured heart rate value plus/minus a tolerance range of a few tenths of a Hertz, for example.

In another exemplary embodiment, the spectral range associated with the perfusion can be determined based on signal intensities in a temporal spectrum of common intensities of a sought region in the registered MR images. The sought region is at least an image unit of the MR images, with the spectrum being created corresponding to one of the spectra as described under Block 103. In order to increase the precision of the determination of the spectral range to be associated with the perfusion, however, a larger region of the registered MR images can be sought and a common intensity value of this region can be calculated. Such a common intensity value can be determined by integrating or summing the individual intensity values of the image units in the sought region, possibly via normalization. In any event, all intensity values of the image units of the sought region make a contribution to the joint intensity value of the sought region. A temporal spectrum is determined relative to the time curve of this common intensity value, for example again via a Fourier transformation over time. The signal intensities of this spectrum provide information about periodic influences in the underlying MR images since these appear as prominent maxima (peaks) in the spectrum. For example, the spectral range to be associated with the perfusion can thus be determined by identifying a maximum of the spectrum determined from the common intensity values that lies in a frequency range between approximately 0.8 Hz and approximately 2 Hz, for example, or which is the local maximum at the highest frequency; and the spectral range is determined as the frequency range of the frequency of this maximum plus/minus a tolerance range of a few tenths of a Hertz or plus/minus twice the half width or a similarly suitable value of this peak, or as the range in which the signal intensities of the spectrum rise to this peak and fall again.

It is possible that second harmonics (in the spectrum determined from the common intensity values) of the maximum just described may occur as additional local maxima. These can be used analogous to the manner just described in order to then determine the spectral range, possibly as a spectral range composed of multiple partial ranges or as a spectral range to be associated with the perfusion.

The spectra determined in Block 103 are filtered (Block 105) on the basis of the defined spectral range to be associated with the perfusion. For example, for this purpose the signal intensities I in the spectra are set to zero in the spectral range just defined. This is illustrated below in FIG. 5.

The filtered spectra are converted back into the time domain, for example via an inverse Fourier transformation, and the time curves so obtained of intensity values of image units of the region selected above are reconstructed into perfusion-corrected MR images (Block 106). The perfusion-corrected MR images thus show the previously selected region wherein unwanted perfusion-dependent signals have been removed.

The perfusion-corrected MR images can be displayed on a display unit of the magnetic resonance system or a terminal, for example, and/or be stored in a memory unit (Block 108).

Furthermore, at least one ventilation value can be determined from the perfusion-corrected MR images by comparing the intensity values of an image region of interest from at least two of the perfusion-corrected MR images (Block 107). This ventilation value or these ventilation values can be displayed and/or stored together with the perfusion-corrected MR images or also separately (Block 108).

The determination of ventilation values is in particular of great use when the MR images of the series of MR images acquired in a chronological progression depict at least a portion of a lung.

For example, the ventilation values are determined as in one of the two aforementioned articles by Zapke et al. or Rupprecht et al.

Common intensity values in at least two of the perfusion-corrected MR images or over the entire time curve are determined in an image region of interest (ROI) for which the ventilation should be determined. This can occur analogously to the common intensity value described with regard to Block 104. The common intensity values are compared by subtraction, for example, wherein a normalization can possibly be implemented to a common intensity value free of noise.

If a perfusion-corrected MR image which represents a state of greatest possible exhalation is used in the comparison, a quantitative ventilation value can be calculated since the volume of the lung can be viewed as zero (empty) in this state. A ventilation value V(n) of a perfusion-corrected MR image n of the series can thus be calculated as:

V(n)=(S_{zero}−S(n))/(S_{zero}−Sᵣ),

wherein S_{zero} is the common intensity value of a perfusion-corrected MR image which represents a state of greatest possible exhalation, S(n) is the common intensity value of the perfusion-corrected MR image n, and Sᵣ is an intensity value associated with the noise.

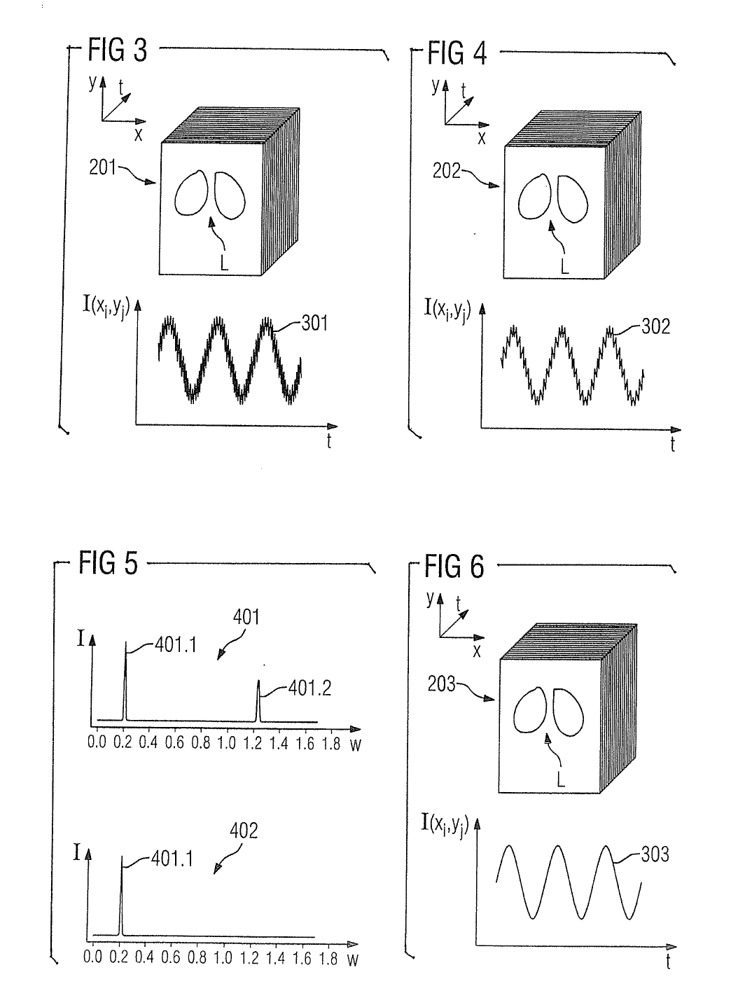

FIG. 3 schematically shows a series of MR images 201 acquired in the chronological progression (along the axis t), which MR images 201 represent at least portions of a lung L, for example. Such a series of MR images was acquired as described above in relation to Step 101 with reference to FIG. 2. In FIG. 3, the curve 301 of the intensity of the acquired signals in the same respective pixel (xᵢ; yⱼ) in each MR image of the series 201 in the course of time t is shown by way of example below the schematic series 201 of MR images. The intensity of the signals is here subjected to both the movement (caused by breathing, for example) of the patient during the acquisition of the MR images and physiological processes such as ventilation and perfusion due to the blood flow in small blood vessels of the lung, as well as noise. The curve of the intensity is accordingly distorted.

FIG. 4 schematically shows a registered series 202 that corresponds to the series 201 from FIG. 3 after the implementation of a registration of the individual MR images of the series with one another. The registration can be implemented as described above with regard to FIG. 2, Step 102. In FIG. 4 the curve 302 of the intensity of the acquired signals in the same respective pixel (xᵢ; yⱼ) in each MR image of the series 202 is likewise schematically shown over the course of time t as an example below the schematic series 202 of MR images. The intensity of the signals here is no longer subjected to the movement of the examination subject (caused by breathing, for example); however the physiological processes such as ventilation and perfusion due to blood flow in small blood vessels of the lung and noise continue to influence the signal intensities. The curve of the intensity is accordingly slightly distorted.

Schematically shown at the top in FIG. 5 is a temporal spectrum 401 (calculated from an intensity curve according to FIG. 4) as a curve of its signal intensity I against the frequency w. The spectrum 401 can be created as described above with regard to FIG. 2, Step 103. The spectrum 401 shown here has two maxima or peaks 401.1 and 401.2.

In comparison to this, a correspondingly filtered spectrum 402 is shown at the bottom in FIG. 5. In the filtered spectrum 402 the second peak 401.2 has been filtered out and replaced with zero values since this peak 40.2 lay in the spectral range to be associated with the perfusion. Otherwise, the filtered spectrum 402 corresponds to the unfiltered spectrum 401.

FIG. 6 schematically shows a series 203 of perfusion-corrected MR images shown in chronological progression which were reconstructed from back-converted, filtered spectra as was described with regard to FIG. 2, Block 106. Below the series is the associated curve 303 of the intensity I of the signals in the same respective pixel (xᵢ; yⱼ) in each MR image of the perfusion-corrected series. The intensity of the signals here is still subjected to only the ventilation of the lung and noise. The curve of the intensity is accordingly slightly distorted.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for removing unwanted, perfusion-dependent signals from magnetic resonance (MR) images, comprising:
loading a series of MR images, each containing perfusion-dependent signals, into a processor that were acquired in a chronological progression and that are in registration with each other, each of said MR images being comprised of a plurality of image units and each image unit having an intensity;
in said processor, generating a spectrum of a time curve in said chronological progression of the intensity of each image unit in a selected region of the MR images that are in registration with each other;
in said processor, determining a spectral range with which perfusion is to be associated;
in said processor, filtering the spectrum dependent on the determined spectral range;
in said processor, reconstructing perfusion-corrected MR images by converting the filtered spectrum back to the time domain; and
from said processor, causing at least one of display of said perfusion-corrected MR images at a display unit, and storage of said perfusion-corrected MR images in an electronic memory unit.

2. A method as claimed in claim 1 comprising loading, as said series of said MR images, a series of MR images that depict at least a portion of a lung.

3. A method as claimed in claim 2 comprising, in said processor, determining at least one ventilation value associated with said lung by comparing the intensity values of image units, and an image region of interest in said selected region, respectively in at least two of said perfusion-corrected MR images.

4. A method as claimed in claim 3 comprising using, as one of said at least two perfusion-corrected MR images, a perfusion-corrected MR image that depicts a state of greatest exhalation of said lung.

5. A method as claimed in claim 1 comprising determining said spectral range based on signal intensities in a temporal spectrum of common intensities of a region of interest in said selected region in said MR images.

6. A method as claimed in claim 1 comprising limiting said spectral range based on a heart rate of a subject from whom said series of MR images were acquired.

7. A method as claimed in claim 1 comprising limiting said spectral range to a range between 0.8 Hz and 2 Hz.

8. A magnetic resonance (MR) imaging system, comprising:
an MR data acquisition unit configured to acquire magnetic resonance data from a subject located in the MR data acquisition unit;
a control unit configured to operate said MR data acquisition unit to acquire magnetic resonance data representing a series of MR images, each comprising perfusion-dependent signals, in a chronological progression and in registration with each other, each of said MR images being comprised of image units and each image unit having an intensity;
a computerized processor in to which said series of MR images is loaded; and
said computerized processor being configured to generate a spectrum of a time curve in said chronological progression of the intensity of each image unit in a selected region of the MR images that are in registration with each other, determine a spectral range with which perfusion is to be associated, filter the spectrum dependent on the determined spectral range, reconstruct perfusion-corrected MR images by converting the filtered spectrum back to the time domain, and cause at least one of display of said perfusion-corrected MR images at a display unit, and storage of said perfusion-corrected MR images in an electronic memory unit.

9. A non-transitory, computer-readable storage medium encoded with programming instructions, said data storage medium being loaded into a computerized processor and said programming instructions being configured to cause said computerized processor to:
receive a series of MR images, each containing perfusion-dependent signals, that were acquired in a chronological progression and that are in registration with each other, each of said MR images being comprised of a plurality of image units and each image unit having an intensity;
generate a spectrum of a time curve in said chronological progression of the intensity of each image unit in a selected region of the MR images that are in registration with each other;
determine a spectral range with which perfusion is to be associated;
filter the spectrum dependent on the determined spectral range;
reconstruct perfusion-corrected MR images by converting the filtered spectrum back to the time domain; and
cause at least one of display of said perfusion-corrected MR images at a display unit, and storage of said perfusion-corrected MR images in an electronic memory unit.
